(19) United States
(12) Patent Application Publication
(10) Pub. No.: US 2011/0197212 A1
(43) Pub. Date: Aug. 11, 2011

(54) Encoder sensor, motor provided with encoder sensor and optical disk driving device equipped with motor

(75) Inventors: Ho Jun Yoo, Suwon (KR); Young Sun Yoo, Suwon (KR); Sang Kyu Lee, Suwon (KR); Yeol Choi, Gwangmyeong (KR)

(73) Assignee: SAMSUNG ELECTRO-MECHANICS CO., LTD., Suwon (KR)

(21) Appl. No.: 12/923,899

(22) Filed: Oct. 13, 2010

(30) Foreign Application Priority Data
Feb. 5, 2010 (KR) 10-2010-0010730

(51) Int. Cl. G11B 19/20; G01D 5/30; H02K 11/00

(52) U.S. Cl. 720/703; 250/230; 310/68 B; G9B/19.028

(57) ABSTRACT

There is provided an encoder sensor according to an exemplary embodiment of the present invention. The encoder sensor may include: a light emitting unit and a light receiving part disposed at a distance in a readable range of an encoding mark of a disk; a receiving part receiving the light emitting unit and the light emitting unit; and a lead frame extending into an opposite direction of the disk from the receiving part and electrically connected to a printed circuit board.

### CROSS-REFERENCE TO RELATED APPLICATIONS

This application claims the priority of Korean Patent Application No. 10-2010-0010730 filed on Feb. 5, 2010, in the Korean Intellectual Property Office, the disclosure of which is incorporated herein by reference.

### BACKGROUND OF THE INVENTION

1. Field of the Invention

The present invention relates to an encoder sensor, a motor provided with the encoder sensor, and an optical disk driving device equipped with the motor, and more particularly, to an encoder sensor capable of reducing the number of parts of the motor by controlling a distance from a disk using only the encoder sensor and simplifying a manufacturing process, a motor provided with the encoder sensor, and an optical disk driving device equipped with the motor.

2. Description of the Related Art

Generally, a spindle motor equipped in an optical disk drive serves to rotate a disk so that an optical pickup mechanism can read data recorded on the disk.

Recently, an optical disk drive using a light scribe function allowing a user to freely print pictures or letters on a surface opposite to that of a recording surface of the optical disk, such as a compact disk (CD), a digital versatile disk (DVD), a blue-ray disk (BRD), or the like, has been continuously released.

The spindle motor should be rotated at a high speed of 12,000 rpm in order to record information on the disk or reproduce the recorded information, but should be rotated at a low speed of about 40 to 300 rpm in order to implement the light scribe function.

In order to rotate the motor at a low speed to implement the light scribe function, an encoding mark should be formed on a surface opposite to the recording surface of the disk and the encoder sensor capable of sensing the encoding mark is required. In this case, the disk in which the surface opposite to the recording surface is formed with the encoding mark is referred to as the light scribe disk.

In order to implement the light scribe function, the encoder sensor should maintain a distance in a readable range capable of sensing the signal of the encoding mark on the surface opposite to the recording surface of the light scribe disk.

The related art has used an encoder sensor support having a predetermined length capable of electrically connecting wirings on a printed circuit board to leads of the encoder sensor in order to maintain the readable range.

As described above, when the encoder sensor support is used, the encoder sensor support is mounted on the printed circuit board and then, the encoder sensor is mounted on the encoder sensor support, such that the manufacturing process is complicated.

Further, since the encoder sensor and the encoder sensor support are separately assembled, the centers thereof do not coincide with each other when parts are assembled, such that a deviation or tilting phenomenon between parts occurs.

In this case, since the leads of the encoder sensor are not exposed to the outside, it is very difficult to confirm whether the surface mounting is stably made on the encoder sensor support.

Further, since the separate parts such as the encoder sensor support are needed, the cost of parts is increased.

### SUMMARY OF THE INVENTION

An aspect of the present invention provides an encoder sensor capable of reducing the number of parts of a motor by controlling a distance from a disk using only the encoder sensor and simplifying a manufacturing process, a motor provided with the encoder sensor, and an optical disk driving device equipped with the motor.

According to an aspect of the present invention, there is provided an encoder sensor, including: a light emitting unit and a light receiving part disposed at a distance in a readable range of an encoding mark of a disk; a receiving part receiving the light emitting unit and the light emitting unit; and a lead frame extending into an opposite direction of the disk from the receiving part and electrically connected to a printed circuit board of a motor.

The encoder sensor may further include a body part contacting the printed circuit board to support the receiving part.

The body part may be injection-molded to be integrally formed with the receiving part.

The body part may include a guide boss inserted into the printed circuit board.

The body part may include at least two guide bosses having different sizes to divide directivity of electrode polarity.

The lead frame may include: a base part formed between the receiving part and the body part; a lead part extending from the base part to be disposed at the outer side of the body part; and a ground part bent from the lead part and electrically connected to the printed circuit board.

The lead frame may include: a base part formed between the receiving part and the body part; a lead part extending into the body part from the base part; and a ground part bent from the lead part and exposed to the outside of the body part to be electrically connected with the printed circuit board.

The light emitting unit and the light receiving part may include a connection terminal connected to the lead frame.

According to another aspect of the present invention, there is provided a motor, including: a base plate including a printed circuit board; a bearing assembly fixed to the base plate and supporting a shaft; a rotor case pressed-fit into the shaft to be fixed and mounted with a chucking device on which a disk formed with an encoding mark for a light scribe is mounted; and an encoder sensor mounted on the printed circuit board at the outer side of the rotor case and including a receiving part receiving a light emitting unit and a light receiving part disposed at a distance in a readable range of an encoding mark of a disk and a lead frame extending into an opposite direction of the disk from the receiving part to be electrically connected to a printed circuit board.

The encoding sensor may further include a body part contacting the printed circuit board to support the receiving part.

The body part may be injection-molded to be integrally formed with the receiving part.

The body part may include a guide boss inserted into the printed circuit board.

The body part may include at least two guide bosses having different sizes to divide directivity of electrode polarity.

The lead frame may include: a base part formed between the receiving part and the body part; a lead part extending from the base part to be disposed at the outer side of the body part; and a ground part bent from the lead part and electrically connected to the printed circuit board.

The lead frame may include: a base part formed between the receiving part and the body part; a lead part extending into the body part from the base part; and a ground part bent from the lead part and exposed to the outside of the body part to be electrically connected with the printed circuit board.

The light emitting unit and the light receiving part may include a connection terminal connected to the lead frame.

According to another aspect of the present invention, there is provided an optical disk driving device, including: a motor; a frame equipped with a motor; an optical pickup mechanism irradiating laser to the disk to implement a light scribe function; and a transferring mechanism transferring the optical pickup mechanism in a diameter direction of the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing an appearance of a motor according to an exemplary embodiment of the present invention;

FIG. 2 is a schematic cross-sectional view taken along line II-II of FIG. 1;

FIG. 3 is a schematic cross-sectional view of an encoder sensor according to a first exemplary embodiment of the present invention;

FIG. 4 is a schematic cross-sectional view of an encoder sensor according to a second exemplary embodiment of the present invention;

FIG. 5 is a schematic cross-sectional view of an encoder sensor according to a third exemplary embodiment of the present invention;

FIG. 6 is a schematic exploded perspective view showing the encoder sensor and a printed circuit board according to the second exemplary embodiment of the present invention;

FIG. 7 is a schematic perspective view showing a shape in which the encoder sensor is mounted on the printed circuit board; and

FIG. 8 is a schematic cross-sectional view of an optical disk driving device according to an exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components within the same spirit, and those are to be construed as being included in the spirit of the present invention.

Further, throughout the drawings, the same or similar reference numerals will be used to designate the same components or like components having the same functions in the scope of the similar idea.

### Motor

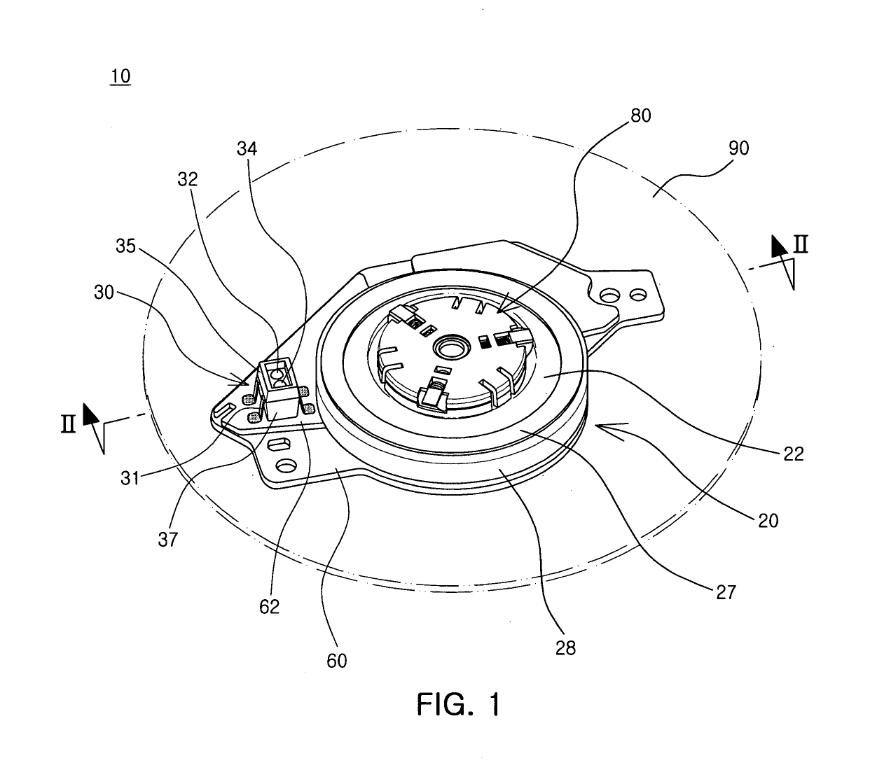

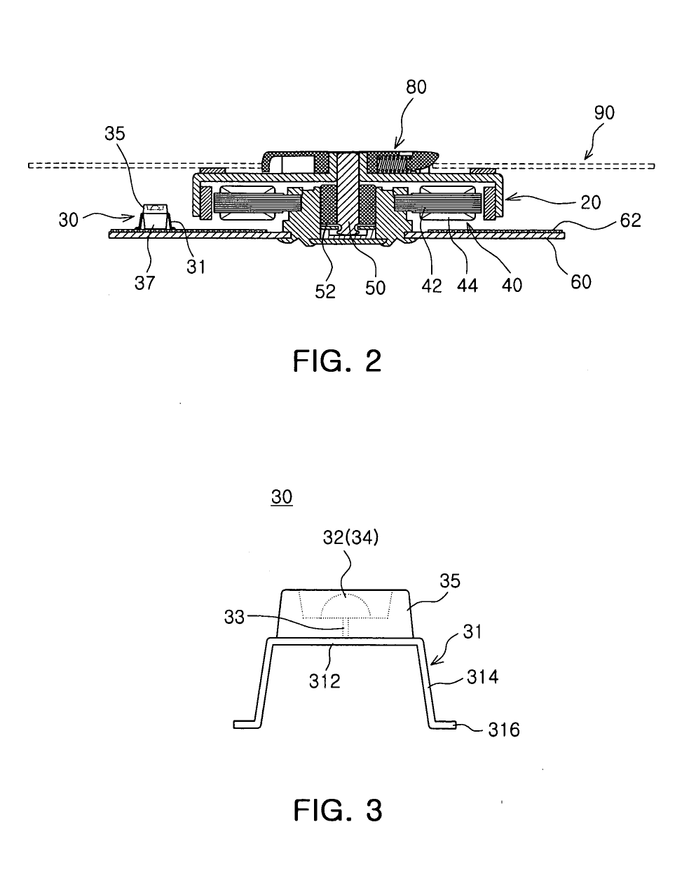

FIG. 1 is a perspective view schematically showing an appearance of a motor according to an exemplary embodiment of the present invention and FIG. 2 is a schematic cross-sectional view taken along line II-II of FIG. 1.

Referring to FIGS. 1 and 2, a motor 10 according to an exemplary embodiment of the present invention may include a base plate 60, a sleeve 52, a rotor case 22, and an encoder sensor 30.

In this case, the motor 10 is a spindle motor used for an optical disk drive rotating a disk D and largely includes a rotor 20 and a stator 40.

First, terms relating to direction will be defined. An axial direction means a vertical direction based an a shaft 50 when being viewed from FIG. 2 and an outer-diameter or inner-diameter direction means an outside end direction of the rotor 20 or a central direction of the shaft 50 based on the outside end of the rotor 20.

The rotor 20 includes a cup-shaped rotor case 22 whose outer peripheral portion is provided with a magnet 25 having annular ring shape corresponding to a coil 46 of the stator 40. The magnet 25 is a permanent magnet generating a magnetic force of a predetermined strength by alternately magnetizing an N pole and an S pole thereof.

The rotor case 22 includes a rotor hub 26 pressed-fit into the shaft 50 to be connected with each other and a magnet connection part 28 of which the inner peripheral surface is provided with the magnet 25 having an annular ring shape. The rotor hub 26 is formed to be bent to the axial upper side in order to maintain an extracting force with the shaft 50 and the outer peripheral portion of the rotor hub 26 is provided with a chucking mechanism 80 capable of mounting a disk 90.

The stator 40 means all the fixing members other than a rotating member. The stator 40 includes a base plate 60 on which a printed circuit substrate 62 is mounted, a sleeve holder 70 pressing-fit the sleeve 52, a core 42 fixed to the sleeve holder 70, and a winding coil 44 surrounding the core.

The magnet 25 provided on the inner peripheral portion of the magnet connection part 28 is disposed to be opposite to the winding coil 44 and the rotor 20 rotates by the electromagnetic interaction of the magnet 25 and the winding coil 44. In other words, when the rotor case 22 rotates, the shaft 50 interconnected with the rotor case 22 rotates.

Meanwhile, the motor 10 according to the exemplary embodiment may include an encoder sensor 30 in order to implement a light scribe function.

The encoder sensor 30 may be disposed on the printed circuit substrate 62 at the outer-diameter direction outside of the rotor case 22. The encoder sensor 30 may include a lead frame 31 having a length that positions a light emitting unit 32 and a light receiving part 34 in a readable range capable of sensing an encoding mark 95 of the disk 90.

The lead frame 31 extends in the opposite direction of the disk 90 to be electrically connected with the printed circuit board 62.

The encoder sensor 30 includes all the technical features of components to be described below and therefore, cites the following description.

### Encoder Sensor

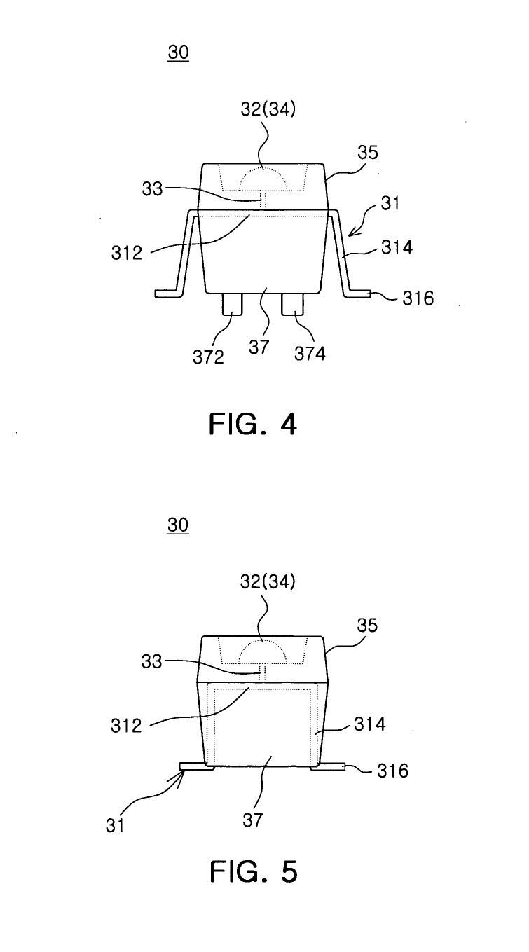

FIG. 3 is a schematic cross-sectional view of an encoder sensor according to a first exemplary embodiment of the present invention, FIG. 4 is a schematic cross-sectional view of an encoder sensor according to a second exemplary embodiment of the present invention, and FIG. 5 is a schematic cross-sectional view of an encoder sensor according to a third exemplary embodiment of the present invention.

Referring to FIGS. 3 to 5, the encoder sensor 30 according to the present invention may include the light emitting unit 32, and the light receiving part 34, a receiving part 35 receiving the light emitting unit 32 and the light receiving part 34, and the lead frame 31.

The light emitting unit 32 irradiates a light beam to the encoding mark 95 formed on the light scribe disk 90 and the light receiving part 34 receives signals of a light beam reflected from the encoding mark 95. The information received in the light receiving part 34 is transferred to a controller (not shown) and the controller controls the motor 10 to rotate at a low speed to enable the light scribe function according to the transferred signals.

The receiving part 35 receives the light emitting unit 32 and the light receiving part 34 and a connection terminal 33 of the light emitting unit 32 and the light receiving part 34 is electrically connected to the lead frame 31 formed on the lower portion of the receiving part 35.

The encoder sensor 30 according to the first exemplary embodiment as shown in FIG. 3 includes the lead frame 31 having a length that positions the light emitting unit 32 and the light receiving part 34 in the readable range capable of receiving the signals of the encoding mark 95.

The lead frame 31 according to the first exemplary embodiment is electrically connected to the printed circuit board 62 and the receiving portion 35 has a space at the axial upper portion on the printed circuit board 62.

As shown in FIGS. 4 and 5, unlike the first exemplary embodiment of FIG. 3, the encoder sensor 30 according to second and third exemplary embodiments may further include a body part 37 that contacts the printed circuit board 62 to support the receiving part 35.

The body part 37 can be made of all the materials without limitation if a portion contacting the lead frame 31 is an insulator and may be injection-molded to be integrally formed with the receiving part 35.

Meanwhile, the body portion 37 of the encoder sensor 30 may include guide bosses 372 and 374 inserted into the printed circuit board. The guide bosses 372 and 374 may be formed to be protruded downwardly from the bottom of the body part 37.

In this configuration, the guide boss 372 may include at least two guide bosses having different sizes in order to be stably supported on the printed circuit board 62 as well as divide the directivity of electrode polarity provided from a wiring 64 on the printed circuit board 62. Although not shown, one guide boss is disposed at a position biased from the center of the body part to divide the directivity of the electrode polarity.

The lead frame 31 may include a base part 312 formed between the receiving part 35 and the body part 37, and a lead part 314, and a ground part 316.

The lead part 314 of the encoder sensor 30 according to a second exemplary embodiment as shown in FIG. 4 extends from the base part 312 and is disposed at the outer side of the body part 37. In addition, one end of the ground part 316 may be formed to be bent so that it is electrically connected to the printed circuit board 62.

Unlike the second exemplary embodiment, the lead part 314 of the encoder sensor 30 according to a third exemplary embodiment as shown in FIG. 5 extends into the body part 37 and the ground part 316 may be exposed to the outside of the body part 37 so that it is bent from the lead part 314 to be electrically connected with the printed circuit board 62.

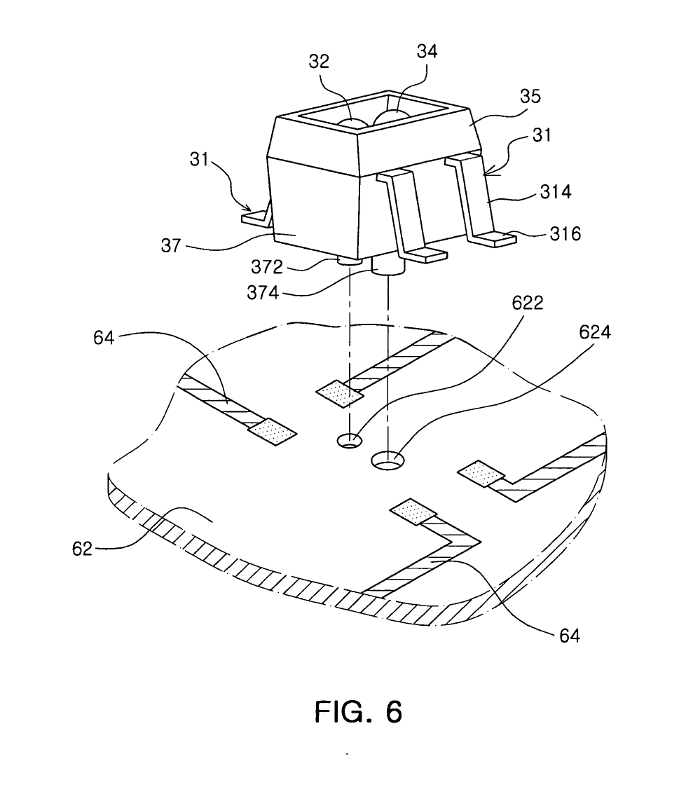

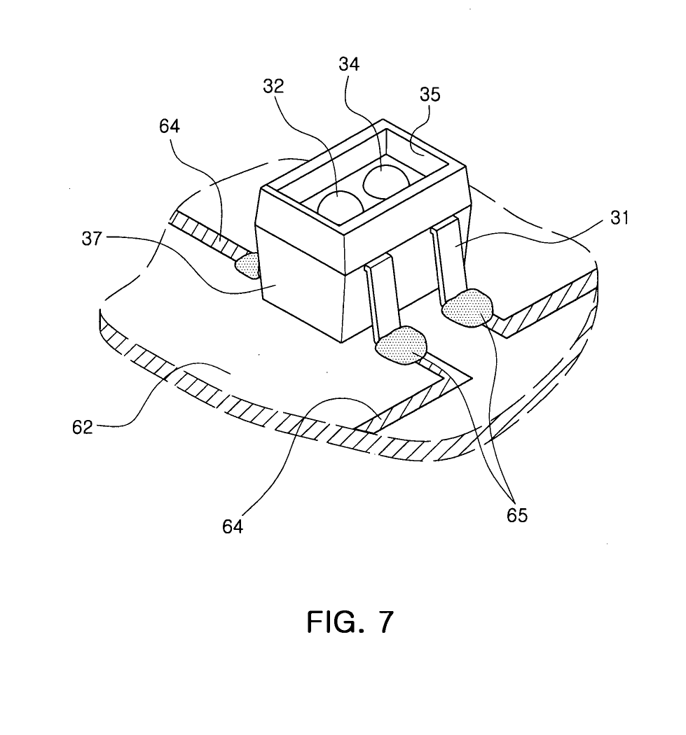

FIG. 6 is a schematic exploded perspective view showing the encoder sensor and a printed circuit board according to the second exemplary embodiment of the present invention and FIG. 7 is a schematic perspective view showing a shape in which the encoder sensor is mounted on the printed circuit board.

FIGS. 6 and 7 show the shape before and after the encoder sensor 30 according to the second exemplary embodiment as shown in FIG. 4 is mounted on the printed circuit board 60.

The guide bosses 372 and 374 protruded from the body part 37 of the encoder sensor 30 may be fixed by being inserted into insert parts 622 and 644 formed on the printed circuit board 62. In this configuration, the guide bosses 372 and 374 have different sizes, thereby making it possible to easily set the directivity meeting the electrode polarity of the wiring 64 of the printed circuit board 62.

Similarly, the encoder sensor 30 including the body part 37 and the guide bosses 372 and 374 according to another exemplary embodiment may be mounted as shown in FIGS. 6 and 7.

The ground part 316 of the encoder sensor 30 is bent from the lead part 314, such that it is formed parallel with the printed circuit board 62. The contacting area of the ground part 316 and the printed circuit board 62 are wide, such that the encoder sensor 30 can be stably supported.

The ground part 316 is mounted on the printed circuit board 62 and is then subjected to a soldering 65, such that it is electrically conducted with the printed circuit board 62. In this configuration, the ground portion 316 is exposed to the outside of the body part 37 and is soldered 65 on the printed circuit board 62. At this time, the soldering can be performed while being confirmed from the outside. Therefore, the stability of the surface mounting can be improved.

### Optical Disk Driving Device

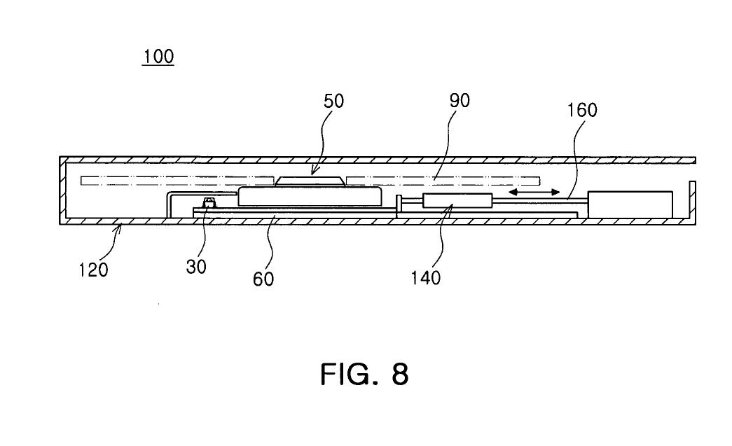

FIG. 8 is a schematic cross-sectional view of an optical disk driving device according to an exemplary embodiment of the present invention.

Referring to FIG. 8, an optical disk driving device 100 according to an exemplary embodiment of the present invention includes a motor 10 having all the technical features as described above.

The optical disk driving device 100 according to the exemplary embodiment of the present invention may include a frame 120 of an optical pickup mechanism 140 and a moving mechanism 160.

The base plate 60 including the printed circuit board 62 on which the motor 10 is mounted may be fixed to the frame 120.

The optical pickup mechanism 140 is disposed outside the motor 10 under the disk 90 in order to implement the light scribe function printing letters or pictures on the disk 90 mounted on the motor 10.

The moving mechanism 160 transfers the optical pickup mechanism 140 in a diameter direction of the disk 90 to implement the light scribe function over the disk 90.

As set forth above, according to the encoder sensor, the motor provided with the encoder sensor, and the optical disk driving device equipped with the motor according to the present invention, the encoder sensor can maintain the readable range from the disk without the separate sensor support.

Further, the present invention can reduce the number of parts to simplify the manufacturing process and mount the encoder sensor on the printed circuit board only once to remove the deviation or tilting phenomenon between parts, thereby improving the readability of the encoding mark.

In addition, the present invention can expose the lead frame of the encoder sensor to the outside to confirm the surface mounting from the outside, thereby making it possible to improve the reliability of surface mounting and the reliability of products.

While the present invention has been shown and described in connection with the exemplary embodiments, it will be apparent to those skilled in the art that modifications and variations can be made without departing from the spirit and scope of the invention as defined by the appended claims.

What is claimed is:

1. An encoder sensor, comprising:
a light emitting unit and a light receiving part disposed at a distance in a readable range of an encoding mark of a disk;
a receiving part receiving the light emitting unit and the light emitting unit; and
a lead frame extending into an opposite direction of the disk from the receiving part and electrically connected to a printed circuit board of a motor.

2. The encoder sensor of claim 1, further comprising a body part contacting the printed circuit board to support the receiving part.

3. The encoder sensor of claim 2, wherein the body part is injection-molded to be integrally formed with the receiving part.

4. The encoder sensor of claim 2, wherein the body part includes a guide boss inserted into the printed circuit board.

5. The encoder sensor of claim 2, wherein the body part includes at least two guide bosses having different sizes to divide directivity of electrode polarity.

6. The encoder sensor of claim 2, wherein the lead frame includes:
a base part formed between the receiving part and the body part;
a lead part extending from the base part to be disposed at the outer side of the body part; and
a ground part bent from the lead part and electrically connected to the printed circuit board.

7. The encoder sensor of claim 2, wherein the lead frame includes:
a base part formed between the receiving part and the body part;
a lead part extending into the body part from the base part; and
a ground part bent from the lead part and exposed to the outside of the body part to be electrically connected with the printed circuit board.

8. The encoder sensor of claim 1, wherein the light emitting unit and the light receiving part include a connection terminal connected to the lead frame.

9. A motor, comprising:
a base plate including a printed circuit board;
a bearing assembly fixed to the base plate and supporting a shaft;
a rotor case pressed-fit into the shaft to be fixed and mounted with a chucking device on which a disk formed with an encoding mark for a light scribe is mounted; and
an encoder sensor mounted on the printed circuit board at the outer side of the rotor case and including a receiving part receiving a light emitting unit and a light receiving part disposed at a distance in a readable range of an encoding mark of a disk and a lead frame extending into an opposite direction of the disk from the receiving part to be electrically connected to a printed circuit board.

10. The motor of claim 9, wherein the encoding sensor further includes a body part contacting the printed circuit board to support the receiving part.

11. The motor of claim 10, wherein the body part is injection-molded to be integrally formed with the receiving part.

12. The motor of claim 10, wherein the body part includes a guide boss inserted into the printed circuit board.

13. The motor of claim 10, wherein the body part includes at least two guide bosses having different sizes to divide directivity of electrode polarity.

14. The motor of claim 10, wherein the lead frame includes:
a base part formed between the receiving part and the body part;
a lead part extending from the base part to be disposed at the outer side of the body part; and
a ground part bent from the lead part and electrically connected to the printed circuit board.

15. The motor of claim 10, wherein the lead frame includes:
a base part formed between the receiving part and the body part;
a lead part extending into the body part from the base part; and
a ground part bent from the lead part and exposed to the outside of the body part to be electrically connected with the printed circuit board.

16. The motor of claim 9, wherein the light emitting unit and the light receiving part include a connection terminal connected to the lead frame.

17. An optical disk driving device, comprising:
a motor of claim 9;
a frame equipped with the motor;
an optical pickup mechanism irradiating laser to the disk to implement a light scribe function; and
a transferring mechanism transferring the optical pickup mechanism in a diameter direction of the disk.
